(19) United States
(12) Patent Application Publication
(10) Pub. No.: US 2026/0119183 A1
(43) Pub. Date: Apr. 30, 2026

(54) Processor Environment Agnostic GPIO Virtualization Protocol for Uninterrupted Peripheral Device Control

(71) Applicant: Dell Products L.P., Round Rock, TX (US)

(72) Inventors: Harish Barigi, Nellore (IN); Thippeswamy D R, Tumkur (IN); Shekar Babu Suryanarayana, Bangalore (IN)

(21) Appl. No.: 18/928,535

(22) Filed: Oct. 28, 2024

(51) Int. Cl. G06F 9/4401

(52) U.S. Cl. CPC G06F 9/4401

(57) ABSTRACT

A firmware management operation. The firmware management operation includes providing an information handling system with a distributed unified BIOS; identifying a processor environment installed on an information handling system from a plurality of processor environments, the processor environment comprising a processor architecture the processor architecture comprising a general purpose input/output (GPIO) circuit, the GPIO circuit comprising a GPIO signal pin; and, performing a processor environment agnostic GPIO virtualization operation via the distributed unified BIOS, the processor environment agnostic GPIO virtualization operation detecting and rectifying a malfunctioning GPIO signal pin.

### BACKGROUND OF THE INVENTION

### Field of the Invention

The present invention relates to information handling systems. More specifically, embodiments of the invention relate to performing a firmware management operation.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

### SUMMARY OF THE INVENTION

In one embodiment the invention relates to a computer-implementable method for performing a firmware management operation, comprising: providing an information handling system with a distributed unified BIOS; identifying a processor environment installed on an information handling system from a plurality of processor environments, the processor environment comprising a processor architecture the processor architecture comprising a general purpose input/output (GPIO) circuit, the GPIO circuit comprising a GPIO signal pin; and, performing a processor environment agnostic GPIO virtualization operation via the distributed unified BIOS, the processor environment agnostic GPIO virtualization operation detecting and rectifying a malfunctioning GPIO signal pin.

In another embodiment the invention relates to a system comprising: a processor; a data bus coupled to the processor; and a non-transitory, computer-readable storage medium embodying computer program code, the non-transitory, computer-readable storage medium being coupled to the data bus, the computer program code interacting with a plurality of computer operations and comprising instructions executable by the processor and configured for: providing an information handling system with a distributed unified BIOS; identifying a processor environment installed on an information handling system from a plurality of processor environments, the processor environment comprising a processor architecture the processor architecture comprising a general purpose input/output (GPIO) circuit, the GPIO circuit comprising a GPIO signal pin; and, performing a processor environment agnostic GPIO virtualization operation via the distributed unified BIOS, the processor environment agnostic GPIO virtualization operation detecting and rectifying a malfunctioning GPIO signal pin.

In another embodiment the invention relates to a computer-readable storage medium embodying computer program code, the computer program code comprising computer executable instructions configured for: providing an information handling system with a distributed unified BIOS; identifying a processor environment installed on an information handling system from a plurality of processor environments, the processor environment comprising a processor architecture the processor architecture comprising a general purpose input/output (GPIO) circuit, the GPIO circuit comprising a GPIO signal pin; and, performing a processor environment agnostic GPIO virtualization operation via the distributed unified BIOS, the processor environment agnostic GPIO virtualization operation detecting and rectifying a malfunctioning GPIO signal pin.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a general illustration of components of an information handling system as implemented in the system and method of the present invention;

FIG. 2 shows a simplified block diagram of multi-processor operating environment;

FIG. 3 shows a simplified block diagram of an architecture-specific distributed firmware management platform;

FIGS. 4a through 4c are a simplified block diagram showing the performance of certain distributed firmware management operations;

FIGS. 5a and 5b, generally referred to as FIG. 5, show a simplified block diagram of a processor environment agnostic GPIO virtualization system of an information handling system (IHS);

FIG. 6 shows a simplified block diagram of a processor environment agnostic GPIO virtualization system; and

FIG. 7 shows a simplified block diagram of a processor environment agnostic GPIO virtualization system which includes a GPIO bridging protocol.

### DETAILED DESCRIPTION

A system, method, and computer-readable medium are disclosed for performing a firmware management operation, described in greater detail herein. Various aspects of the invention reflect an appreciation that it is not uncommon for certain firmware components of a Basic Input/Output System (BIOS) associated with an information handling system (IHS) to be added, deleted, updated, revised, replaced, or restored over time. Likewise, various aspects of the invention reflect an appreciation that such BIOS firmware components are often added, deleted, updated, revised, replaced, or restored to provide security updates, fix known software bugs, improve performance, add new features and functionalities, and so forth.

Various aspects of the invention reflect an appreciation that processors are often configured with one or more general purpose input/output (GPIO) signal circuits (often referred to as GPIOs). Various aspects of the present disclosure include an appreciation that each GPIO signal circuit may be configured to provide one or more GPIO signal pins or GPIO signal lines (which are also often referred to as GPIOs). Various aspects of the present disclosure include an appreciation that native functions multiplexed on these signal pins are often divided into several classes. Various aspects of the present disclosure include an appreciation that one such class relates to GPIO voltage settings. Various aspects of the present disclosure include an appreciation that with the voltage setting class of GPIOs, several GPIO signal pins as well as multiplexed native functions of the processor, can be configured to operate in a 3.3V mode of operation or in a 1.8V mode of operation.

Various aspects of the present disclosure includes an appreciation that each GPIO signal pin can be configured as a receiver (RX) path or transmitter (TX) path, each which can be enabled by configuration registers. Various aspects of the present disclosure include an appreciation that a GPIO buffer also may contain several termination options of different directions and magnitudes, labeled, for example as, R1up, R2up, R3down, etc. Various aspects of the present disclosure include an appreciation that the termination options are often configured as termination resistors which may be connected to a voltage or to ground. These termination resistors are selectable by configuration registers and the signal is pulled up by default to high level via an on-die or on-board resistor and transmission of a 0 is achieved by driving a low level on the signal and vice-versa.

Various aspects of the invention reflect an appreciation that potential configurations of GPIO buffer pins can lead to degradation, often due to weak pull-up circuitry within the pin circuitry. For example, with certain systems, degradation has been found in GPIO buffers used for display port (DP), embedded display port (eDP) or high definition multimedia interface (HDMI) hot plug detect signals, a secure digital (SD) card write protect signal, or a combination thereof.

Various aspects of the present disclosure include an appreciation that system support issues have been identified due to GPIO malfunctions, across a plurality of processor environments. Various aspects of the present disclosure include an appreciation that certain GPIO malfunctions can cause a GPIO pin voltage level pull down to 0V and +/−5V permanently. With such a malfunction, even a system reset, firmware update, or combination thereof, could not recover the platform. As a consequence of this malfunction, issues associated with hot plugging DP/eDP/HDMI have been identified. Additionally, inter integrated circuit (I2C) and system management bus (SMBus) issues relating to this malfunction have been identified which can result in improper functionality of system health monitoring functions. Additionally, SD card detection issues relating to this malfunction have been identified.

Various aspects of the present disclosure include an appreciation that GPIO termination for fast serial peripheral interface (SPI) GPIO on various processor types can be set by a SPI controller. Various aspects of the present disclosure include an appreciation that when the SPI controller sets the SPI GPIO in native termination mode (e.g., a PDA_CFG_DW1_x.TERM=0xF setting), pull-up or pull-down termination resistors in the GPIO are engaged via example register setting. Due to the aforementioned termination issue, SPI write protection and access has been observed to malfunction, thus disabling SPI data communication and not allowing for successful firmware update.

Various aspects of the present disclosure include an appreciation that a GPIO pin experiencing hardware malfunctions, such as passive components holding on to the lines in a specific state (e.g., a Pull Up/Down−PAD_CFG_DW1_GPIO_xxx.IOSTATE setting and a PAD_CFG_DW1_GPIO_xxx.IOTERM setting), leads to platform reliability issues. Various aspects of the present disclosure include an appreciation that these platform reliability issues can result in a need to return the malfunctioning system to the manufacturer for debug and repair. This process not only incurs financial costs for the manufacturer, but also results in the customer losing both time and money.

Various aspects of the present disclosure include an appreciation that GPIO pins, such as the DP_AUX Bias GPIO pins, have shown a tendency to be held in only one state. This issue has resulted in sudden disruptions or abnormalities in system functionality. Various aspects of the present disclosure include an appreciation that it would be desirable to provide a processor environment agnostic GPIO virtualization operation which can address the aforementioned GPIO issues.

A system and method are disclosed for performing a processor environment agnostic GPIO virtualization operation. In certain embodiments, the processor environment agnostic GPIO virtualization operation detects and rectifies a malfunctioning GPIO line. In certain embodiments, the malfunctioning GPIO line is associated with a peripheral device of the information handling system.

In certain embodiments, the processor environment agnostic GPIO virtualization operation provides a firmware managed GPIO control register set. In certain embodiments, the firmware management GPIO control register set is provided by initializing firmware memory mapped virtual GPIO pins. In certain embodiments so initialized, the firmware memory mapped virtual GPIO pins enable dynamic control of GPIO pin signals. In certain embodiments, the dynamic control of the GPIO pin signals allows GPIO device functions to be reset.

In certain embodiments, the processor environment agnostic GPIO virtualization operation includes a virtual GPIO swap protocol. In certain embodiments, the virtual GPIO swap protocol enables swapping of a malfunctioning GPIO line from a peripheral device with a new operation memory area and reinitializes the malfunctioning GPIO line to an original functional state. In certain embodiments, the swapping is performed without having to reboot the system.

In certain embodiments, the processor environment agnostic GPIO virtualization operation enables new GPIO functions introduced by processor environment vendors to be enabled without a vendor released firmware update. In certain embodiments, the processor environment agnostic GPIO virtualization operation uses the virtual GPIO swap protocol to swap the new GPIO function with a new operation memory area and initializes the GPIO line to a functional state for the new GPIO function.

In certain embodiments, the processor environment agnostic GPIO virtualization operation includes a GPIO bridging protocol. In certain embodiments, the GPIO bridging protocol dynamically extends a functional range for a GPIO pin across multiple devices. In certain embodiments, dynamically extending the functional range of the GPIO pin avoids a need for a firmware update. In certain embodiments, peripheral device suppliers can provide specific code implementations to support any new GPIO functions.

In certain embodiments, the processor environment agnostic GPIO virtualization operation includes a firmware managed virtual GPIO protocol. In certain embodiments, the firmware managed virtual GPIO protocol enables zero touch rectification of malfunctioning peripheral devices that are mapped to a malfunctioning GPIO pin. In certain embodiments, the firmware managed virtual GPIO protocol enables seamless device functionality restoration without a firmware update and without need of a system reboot.

In certain embodiments, the processor environment agnostic GPIO virtualization operation effectively reduces debug analysis if the issues are from a GPIO malfunctioning. In certain embodiments, the processor environment agnostic GPIO virtualization operation enables GPIO reassignment without the need for a vendor supported firmware update. In certain embodiments, the processor environment agnostic GPIO virtualization operation can be performed in the background without the notice to a user.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, read-only memory (ROM), and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

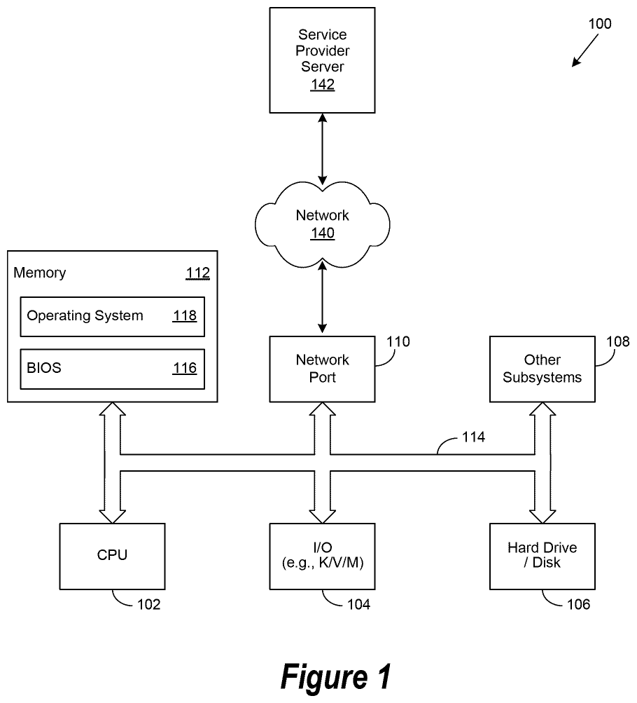

FIG. 1 is a generalized illustration of an information handling system that can be used to implement the system and method of the present invention. In certain embodiments, the information handling system (IHS) 100 may be implemented to include a processor (e.g., central processor unit or “CPU”) 102, various input/output (I/O) devices 104, such as a display, a keyboard, a mouse, a touchpad, or a touchscreen, and associated controllers, a hard drive or disk storage 106, and various other subsystems 108. In various embodiments, the IHS 100 may also be implemented to include a network port 110 operable to connect to a network 140, which in turn may be implemented to provide access to a service provider server 142. In various embodiments, the IHS 100 may likewise be implemented to include system memory 112, which is interconnected to the foregoing via one or more buses 114.

In various embodiments, system memory 112 may be configured to store program code, or data, or both, which in turn may be implemented to be accessible and executable by the CPU 102. In various embodiments, system memory 112 may be implemented using any suitable memory technology. Examples of such memory technology include random access memory (RAM), static RAM (SRAM), dynamic RAM (DRAM), synchronous dynamic RAM (SDRAM), non-volatile RAM (NVRAM), read-only memory (ROM), erasable programmable read-only memory (EPROM), electrically erasable programmable ROM (EEPROM), complementary metal-oxide-semiconductor (CMOS) memory, flash memory, or any other type of computer memory, whether it may be volatile or non-volatile. In various embodiments, system memory 112 may include one or more dual in-line memory modules (DIMMs), each containing one or more RAM modules mounted onto an integrated circuit board.

In various embodiments the system memory 112 may further be implemented to include a Basic Input/Output System (BIOS) 116, or an operating system (OS) 118, or both. Skilled practitioners of the art will be aware that BIOS 116, also known as System BIOS, ROM BIOS, or personal computer (PC) BIOS, is a type of firmware used to provide runtime services for an OS 118 to perform hardware initialization during the booting process of an IHS 100. Those of skill in the art will likewise be aware that firmware is a combination of persistent memory, program code, and data that provides low-level control of an IHS's 100 hardware. In various embodiments, the BIOS 116 may be implemented to initialize and test certain hardware components of its associated IHS 100 during the booting process (e.g., Power-On Self-Test, or “POST”), followed by loading a boot loader from a particular mass storage device, which in turn may then be used to initialize a kernel.

In various embodiments, such BIOS 116 firmware may be implemented to provide hardware abstraction services to higher-level software such as an OS 118. In various embodiments, BIOS 116 firmware may be implemented in a less complex IHS 100 as an OS 118, performing all control, monitoring, and data manipulation functions. In various embodiments, certain components of a particular IHS 100 may be implemented to have its own firmware, which may store operational variables, data structures, or in general, any sort of information.

In various embodiments, NVRAM may be implemented to store a BIOS 116 associated with the IHS 100. In various embodiments, the NVRAM may also be implemented to hold the initial processor instructions required to bootstrap the IHS 100, store calibration constants, passwords, or setup information, or a combination thereof. In various embodiments, such setup information may be stored as variables in the NVRAM such that the variables are available during system boot from a power-off state. Various embodiments of the invention reflect an appreciation that such variables may need to be modified, revised, updated, restored, or replaced from time to time if they become corrupted. In various embodiments, an NVRAM driver may be implemented to use NVRAM headers to initialize and enable read/write services for updating or restoring such variables. Accordingly, as it relates to various embodiments of the invention, the terms “firmware,” “NVRAM,” or “BIOS” may be used generically and interchangeably.

In various embodiments, the functionality of a BIOS 116 may be implemented according to the Unified Extensible Firmware Interface (UEFI) specification, which describes how an IHS's 100 firmware interacts with a particular OS 118. Various embodiments of the invention reflect an appreciation that UEFI, as typically implemented, may offer certain features and benefits that are not available from traditional BIOS 116 implementations, such as faster boot times, improved security, support for larger storage devices, and higher definition graphical user interfaces (GUIs). In addition, UEFI stores all data related to the IHS's 100 initialization and startup within an .efi file, rather than on its associated firmware. In typical implementations, the .efi file may be stored on a special memory partition known as an EFI System Partition (ESP), which also contains the IHS's 100 bootloader.

In various embodiments, BIOS 116 may be instantiated as a distributed BIOS 116. As used herein, a distributed BIOS 116 broadly refers to a BIOS 116 that includes a plurality of BIOS 116 components, or a plurality of BIOS 116 variables, or a plurality of BIOS 116 storage locations, or a combination thereof. In various embodiments, the distributed BIOS 116 may be implemented to function with any of a plurality of processor environments, described in greater detail herein. In certain embodiments, the distributed BIOS 116 may be implemented as a distributed unified BIOS. As used herein, a distributed unified BIOS 116 broadly refers to a BIOS 116 that includes a plurality of BIOS 116 components, or a plurality of BIOS 116 variables, or a plurality of BIOS 116 storage locations, or a combination thereof, which are implemented to function with any of a plurality of processor environments, described in greater detail herein.

In various embodiments, the IHS 100 may be implemented to perform a firmware management operation. As used herein, a firmware management operation broadly refers to any task, function, operation, procedure, or process performed, directly or indirectly, to store, retrieve, aggregate, disaggregate, add, delete, modify, revise, update, replace, or restore one or more individual BIOS 116 components, described in greater detail herein, or one or more individual BIOS 116 variables, likewise described in greater detail herein, or a combination thereof, in one or more memory 112 locations associated with a particular IHS 100. In various embodiments, the firmware management operation may be implemented to include the performance of a processor environment agnostic GPIO virtualization operation.

In various embodiments, a processor agnostic GPIO virtualization system performs the processor environment agnostic GPIO virtualization operation. In certain embodiments, the processor environment agnostic GPIO virtualization operation detects and rectifies a malfunctioning GPIO line. In certain embodiments, the malfunctioning GPIO line is associated with a peripheral device of the information handling system.

In certain embodiments, the processor environment agnostic GPIO virtualization operation provides a firmware managed GPIO control register set. In certain embodiments, the firmware management GPIO control register set is provided by initializing firmware memory mapped virtual GPIO pins. In certain embodiments so initialized, the firmware memory mapped virtual GPIO pins enable dynamic control of GPIO pin signals. In certain embodiments, the dynamic control of the GPIO pin signals allows GPIO device functions to be reset.

In certain embodiments, the processor environment agnostic GPIO virtualization operation includes a virtual GPIO swap protocol. In certain embodiments, the virtual GPIO swap protocol enables swapping of a malfunctioning GPIO line from a peripheral device with a new operation memory area and reinitializes the malfunctioning GPIO line to an original functional state. In certain embodiments, the swapping is performed without having to reboot the system.

In certain embodiments, the processor environment agnostic GPIO virtualization operation enables new GPIO functions introduced by processor environment vendors to be enabled without a vendor released firmware update. In certain embodiments, the processor environment agnostic GPIO virtualization operation uses the virtual GPIO swap protocol to swap the new GPIO function with a new operation memory area and initializes the GPIO line to a functional state for the new GPIO function.

In certain embodiments, the processor environment agnostic GPIO virtualization operation includes a GPIO bridging protocol. In certain embodiments, the GPIO bridging protocol dynamically extends a functional range for a GPIO pin across multiple devices. In certain embodiments, dynamically extending the functional range of the GPIO pin avoids a need for a firmware update. In certain embodiments, peripheral device suppliers can provide specific code implementations to support any new GPIO functions.

In certain embodiments, the processor environment agnostic GPIO virtualization operation includes a firmware managed virtual GPIO protocol. In certain embodiments, the firmware managed virtual GPIO protocol enables zero touch rectification of malfunctioning peripheral devices that are mapped to a malfunctioning GPIO pin. In certain embodiments, the firmware managed virtual GPIO protocol enables seamless device functionality restoration without a firmware update and without need of a system reboot.

In certain embodiments, the processor environment agnostic GPIO virtualization operation effectively reduces debug analysis if the issues are from a GPIO malfunctioning. In certain embodiments, the processor environment agnostic GPIO virtualization operation enables GPIO reassignment without the need for a vendor supported firmware update. In certain embodiments, the processor environment agnostic GPIO virtualization operation can be performed in the background without the notice to a user.

In certain embodiments, the processor environment agnostic GPIO virtualization operation provides a processor environment agnostic remap function. In certain embodiments, the processor agnostic remap function remaps processor GPIO pins across a plurality of processor environments. In certain embodiments, the processor agnostic remap function maps GPIO configuration sets into a secure IO map region. In certain embodiments, the processor environment agnostic GPIO virtualization operation allows a malfunctioning GPIO circuit to be reinitialized without requiring a reboot. In certain embodiments, the processor environment agnostic GPIO virtualization reinitializes malfunctioning GPIO circuit during OS runtime.

In certain embodiments, the processor environment agnostic GPIO virtualization operation enables auxiliary GPIO pins to be dynamically remapped, initialized, re-enumerated, or a combination thereof. In certain embodiments, the auxiliary GPIO pins include display port auxiliary GPIO pins. In certain embodiments, the processor environment agnostic GPIO virtualization operation enables a functional port for an auxiliary device such as a display port type auxiliary device.

In certain embodiments, the processor environment agnostic GPIO virtualization operation enables re-initialization of a SMBus such as a I2C type communication bus within reboot. In certain embodiments, the re-initialization of the SMBus enables communication with an embedded controller without a reboot. In certain embodiments, the communication with an embedded controller is via a MBOX channel of the embedded controller.

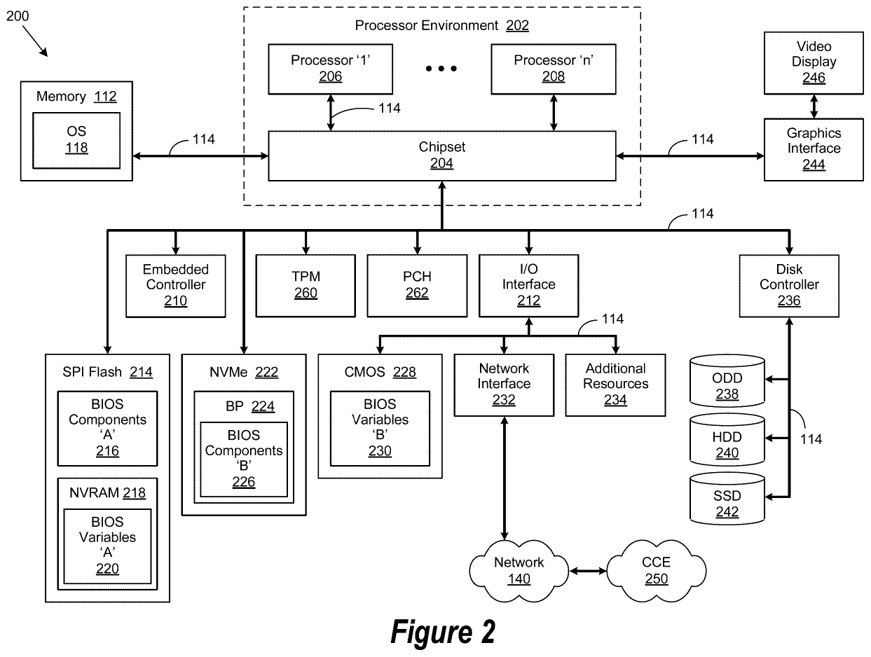

FIG. 2 shows a simplified block diagram of multi-processor operating environment implemented in accordance with an embodiment of the invention. As used herein, a multi-processor operating environment 200, such as that shown in FIG. 2, broadly refers to any instrumentality, or aggregate of instrumentalities, that may be implemented to compute, classify, process, transmit, receive, retrieve, originate, switch, store, display, manifest, detect, record, reproduce, handle, or utilize, or a combination thereof, any form of information, intelligence, or data for business, scientific, control, entertainment, or other purpose, through the use of a particular processor environment (PE) 202. For example, the multi-processor environment 200 may be implemented as an information handling system (IHS), described in greater detail herein, such as a personal computer, a laptop computer, a smart phone, a tablet computer or other consumer electronic device, a network server, a network storage device, or other network communication device, and so forth. In various embodiments, a multi-processor operating environment 200 may be implemented to include processing resources for executing machine-executable code, such as a central processing unit (CPU), a programmable logic array (PLA), an embedded device such as a System-on-a-Chip (SoC), or other control logic hardware.

In various embodiments, the multi-processor operating environment 200 may be implemented to include a PE 202. In various embodiments, the PE 202 may be implemented to include a chipset 204 and one or more processors ‘1’ 206 through ‘n’ 208. In various embodiments, the processors ‘1’ 206 through ‘n’ 208 implemented within a PE 202 may have the same, or different, architectures. In various embodiments, a chipset 204 may be implemented to support one or more architectures corresponding to the processors ‘1’ 206 through ‘n’ 208. In various embodiments, the one or more architectures can include an ×86 type processor architecture, an Advanced Reduced Instruction Set Computer (RISC) Machines (ARM) type processor architecture, or a combination thereof. In various embodiments, a processor environment implementing an ×86 type processor architecture provides an ×86 type processor environment. In various embodiments, a processor environment implementing an ARM type processor architecture provides an ARM type processor environment.

As an example, processors ‘1’ 206 through ‘n’ 208 of a particular PE 202 may be implemented to be the same in a server. In this example, each processor may be assigned to be a resource to one or more virtual machines (VMs). As another example, processor ‘1’ 206 may be implemented as a multi-core processor in a graphics work station, while processor ‘n’ 208 may be implemented a Graphics Processing Unit (GPU), familiar to skilled practitioners of the art.

In various embodiments, each of the processors ‘1’ 206 through ‘n’ 208 of a particular PE 202 may be implemented to run the same OS 118. Likewise, individual processors ‘1’ 206 through ‘n’ 208 of a particular PE 202 may be implemented in various embodiments to run a different same OS 118. For example, processor ‘1’ 206 may be implemented to run Microsoft® Windows®, while processor ‘n’ 208 may be implemented to run a version of Linux®.

In various embodiments, one or more PEs 202 selected from a plurality of PEs 202 may be implemented within the multi-processor operating environment 200. In certain of these embodiments, a particular PE 202 selected from a plurality of PEs 202 may be vendor-specific. In various embodiments, a particular PE 202 selected from a plurality of PEs 202 may be implemented as a System on a Chip (SoC), familiar to those of skill in the art. In various embodiments, the PE 202 may be implemented to include a plurality of vendor-specific SoCs provided by different vendors, or different versions of an SoC provided by the same vendor.

In various embodiments, the multi-processor operating environment 200 may likewise be implemented to include system memory 112. In various embodiments, the system memory 112 may in turn be implemented to include an operating system (OS) 118. In various embodiments, the multi-processor operating environment 200 may be implemented to include an embedded controller (EC) 210, a Trusted Platform Module (TPM) 260, a Platform Controller Hub (PCH) 262, an input/output (I/O) interface 212, a disk controller 236, and a graphics interface 244, or a combination thereof.

In various embodiments, the multi-processor operating environment 200 may likewise be implemented to include Nonvolatile Random Access Memory (NVRAM) 218, Serial Peripheral Interface (SPI) Flash memory 214, Nonvolatile Memory Express (NVMe) 222 memory, and a complementary metal-oxide-semiconductor (CMOS) 228 chip, or a combination thereof. Skilled practitioners of the art will be familiar with NVRAM 218, which in general usage broadly refers to Random Access Memory (RAM) that retains data if power is lost. In various embodiments, NVRAM 218 may be implemented to hold initial processor instructions used to bootstrap an information handling system (IHS), described in greater detail herein. In various embodiments, NVRAM 218 may be implemented in the form of flash memory, such as SPI Flash 214 memory, Erasable Programmable Read-Only Memory (EPROM), Electrically Erasable Programmable Read-Only Memory (EEPROM), or Ferroelectric RAM (F-RAM), Magnetoresistive RAM (MRAM), Phase-Change RAM (PRAM), or a combination thereof.

Those of skill in the art will likewise be familiar with SPI Flash 214 memory, which is a type of EEPROM memory implemented in accordance with the SPI standard, where the data stored within it is architecturally arranged in blocks. Various embodiments of the invention reflect an appreciation that while data stored within SPI Flash memory 214 is erased at the block level, it may be read or written at the byte level. Likewise, various embodiments of the invention reflect an appreciation that the ability to erase blocks of data within SPI Flash 214 memory may be advantageous in certain embodiments as erase speeds can be improved, and as a result, allow information to be stored more efficiently and compactly.

Likewise, skilled practitioners of the art will be familiar with NVMe, which is an open, logical device interface specification for accessing non-volatile storage media implemented within an IHS. Certain embodiments of the invention reflect an appreciation that NVMe 222 memory is currently available in various form factors, such as solid state drives (SSDs), Peripheral Component Interconnect Express (PCIe) memory cards, and M.2 memory cards. Various embodiments of the invention likewise reflect an appreciation that NVMe, as a logical device interface, is able to support low latency and internal parallelism for solid state storage devices, which can reduce Input/Output (I/O) overhead while providing other known performance improvements.

In various embodiments, the SPI Flash 214 memory may be implemented to receive, store, manage, and provide access to one or more Basic Input/Output System (BIOS) components ‘A’ 216. As used herein, a BIOS component broadly refers to one or more discrete portions of firmware program code that may be used, directly or indirectly, by a BIOS during its operation. In various embodiments, the SPI Flash 214 memory may be implemented to include certain NVRAM 218 memory. In various embodiments, the NVRAM 218 memory may in turn be implemented to receive, store, manage, and provide access to one or more BIOS variables ‘A’ 220, such as configuration settings, for use by the BIOS of an associated IHS.

In various embodiments, the NVMe 222 memory may be implemented to include a boot partition (BP) 224. Those of skill in the art will be familiar with the concept of a BP 224, which in common usage broadly refers to a primary memory partition that contains a boot loader, which is a portion of program code responsible for booting the OS 118 of an associated IHS. In various embodiments, the BP 224 may in turn be implemented to receive, store, manage, and provide access to one or more BIOS components ‘B’ 226. In various embodiments, the NVMe 222 memory may be implemented without a BP 224. Nonetheless, the NVMe 222 memory may be implemented in certain of these embodiments to still receive, store, manage, and provide access to one or more BIOS components ‘B’ 226.

In various embodiments, the I/O interface 212 may be implemented to interact with a complementary metal-oxide semiconductor (CMOS) 228 chip. In various embodiments, the CMOS 228 chip may be implemented to include a real-time clock and RAM memory that is backed-up by a battery. In various embodiments, the memory in the CMOS 228 chip may be implemented to receive, store, manage, and provide access to one or more BIOS variables ‘B’ 230.

In various embodiments, the I/O interface 212 may likewise be implemented to interact with a network interface 232, or additional resources 234. or both. In various embodiments, the network interface 232 may be implemented to provide access and connectivity to a network 140. In turn, the network 140 may be implemented in various embodiments to provide access and connectivity to a cloud computing environment (CCE) 250. Skilled practitioners of the art will be familiar with cloud computing, which is defined by the National Institute of Standards and Technology (NIST) as a model for enabling ubiquitous, convenient, on-demand network access to a shared pool of configurable computing resources (e.g., networks, servers, storage, applications, portions of program code, firmware components, data, services, and so forth) that can be rapidly provisioned and released with minimal management effort or service provider interaction.

In various embodiments, additional resources 234 may include a data storage system, additional graphics interfaces, a network interface card (NIC), a sound or video processing card, and so forth. In various embodiments, additional resources 234 may be implemented on a main circuit board of an IHS, or a separate circuit board or add-in card thereof, or a device that is external to the IHS, or a combination thereof. In various embodiments, the disk controller 236 may be implemented to interact with, and manage access to and from, an optical disk drive (ODD) 238, a hard disk drive (HDD) 240, or a solid state drive (SSD) 242, or a combination thereof.

In various embodiments, the graphics interface 242 may be implemented to present visual content on an associated video display. In certain of these embodiments, the graphics interface 242 may likewise be implemented to receive user gesture input from the video display 244, such as through the use of a touch-sensitive screen. In various embodiments, the system memory 112, the chipset 204, one or more processors ‘1’ 206 through ‘n’ 208, the EC 210, the TPM 260, the PCH 262, the SPI Flash 214 memory, the NVMe 222 memory, the I/O interface 212, the CMOS 228 chip, the network interface 232, the additional resources 234, the disk controller 236, the ODD 238, the HDD 240, the SSD 242, the graphics interface 244, and the video display 246 may be implemented to provide and receive data to and from one another via one or more buses 114.

In various embodiments, a firmware management operation may be implemented to include a distributed firmware management operation. As used herein, a distributed firmware management operation broadly refers to a firmware management operation, described in greater detail herein, performed directly, or indirectly, within a multi-processor operating environment 200 to store, retrieve, aggregate, disaggregate, add, delete, modify, revise, update, replace, or restore one or more BIOS components ‘A’ 216 or ‘B’ 226, or one or more BIOS variables ‘A’ 220 or ‘B’ 230, or a combination thereof. In various embodiments, one or more BIOS components ‘A’ 216 or ‘B’ 226, or one or more BIOS variables ‘A’ 220 or ‘B’ 230, or a combination thereof, may be used, individually or in combination with one another, in the performance of a distributed firmware management operation. In various embodiments, performance of the distributed firmware management operation effectively decouples (i.e., minimizes the interrelationship between) one or more BIOS components ‘A’ 216 or ‘B’ 226, or one or more BIOS variables ‘A’ 220 or ‘B’ 230, or a combination thereof, from each other. In various embodiments, the performance of the distributed firmware management operation effectively decouples PE BIOS components from other platform BIOS components, as described herein.

In various embodiments, individual BIOS components ‘A’ 216 or ‘B’ 226 used in the performance of one or more distributed firmware management operations may be located within, or outside of, the multi-processor operating environment 200. As an example, a particular BIOS component ‘A’ 216 or ‘B’ 226 may initially be stored within a cloud computing environment (CCE) 250, described in greater detail herein. In this example, the firmware component may be retrieved from the CCE 250 by the multi-processor operating environment 200 and then respectively stored as firmware components ‘A’ 216 in NVRAM 218, or ‘B’ 226 in NVMe 222 memory, or a combination of the two.

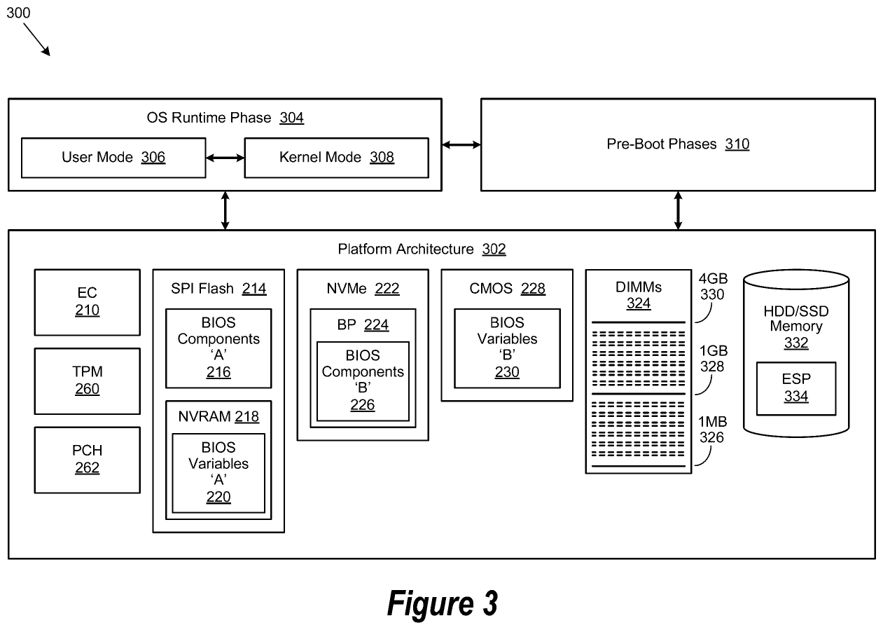

FIG. 3 shows a simplified block diagram of an architecture-specific distributed firmware management platform implemented in accordance with an embodiment of the invention. In various embodiments, the architecture-specific distributed firmware management platform (ASDFMP) 300, and its associated operation, may be implemented to accommodate architecture-specific aspects of a particular information handling system (IHS), described in greater detail herein. As an example, various IHS's may utilize different processors (e.g., Intel®, AMD®, Qualcom® Broadcom®, Nvidia®, and so forth), and as a result, may require the use of a Basic Input/Output System (BIOS) specific to their respective architecture, or associated operating system (OS), or both, at boot time. In various embodiments, the ASDFMP 300 may be implemented to perform one or more firmware management operations, described in greater detail herein.

In various embodiments, the ASDFMP 300 may be implemented to include a platform architecture 302. In certain of these embodiments, the platform architecture 302 may be implemented to include an embedded controller (EC) 210, a Trusted Platform Module (TPM) 260, a Platform Controller Hub (PCH) 262, Serial Peripheral Interface (SPI) Flash 214 memory, Nonvolatile Memory Express (NVMe) 222 memory, and a complementary metal-oxide-semiconductor (CMOS) 228 chip, or a combination thereof, each of which may be considered a component of an information handling system (IHS), as described in greater detail herein. In various embodiments, the platform architecture 302 may likewise be implemented to include one or more dual in-line memory modules (DIMMs) 324, and certain hard disk drive (HDD) memory, or solid state drive (SSD) memory, or a combination of the two 332.

In various embodiments, the EC 210 may be implemented, directly or indirectly, within the ASDFMP 300 to provide a root of trust function. As used herein, a root of trust broadly refers to a highly reliable component, such as an EC 210, that performs specific, important security functions. In various embodiments, a root of trust component may be implemented as a building block upon which other components of the ASDFMP 300 can derive security functions.

In various embodiments, the EC 210 may be implemented to perform a root of trust operation. As used herein, a root of trust operation broadly refers to a distributed firmware management operation, described in greater detail herein, performed directly, or indirectly, within an ASFDMP 300 to provide a root of trust by leveraging a secure interface to ensure integrity and security of communication between certain components of the ASDFMP 300. In various embodiments, one or more root of trust operations may be performed to enhance the security and trustworthiness of the ASDFMP 300.

Skilled practitioners of the art will be familiar with a TPM 260, which is an international standard for a secure crypto processor, typically implemented as a dedicated microcontroller designed to secure various hardware components of an ASDFMP 300 through the use of integrated cryptographic keys. In various embodiments, a TPM 260 may be implemented to increase the security of an ASDFMP 300 and to protect it against certain firmware attacks. In various embodiments, a TPM 260 may be implemented in combination with an EC 210 to perform a root of trust operation.

Those of skill in the art will likewise be familiar with a PCH 262, which broadly refers to a family of chipsets manufactured by Intel® to control certain data paths and support functions used in conjunction with Intel® processors. However, as used herein, a PCH 262 may broadly refer to one or more processor-agnostic functionalities of an ASDFMP 300 that may be used, directly or indirectly within it, to control various data paths and support functions associated with a particular processor. Examples of such processors include those manufactured by Intel®, AMD®, Qualcomm®, Broadcom®, Nvidia®, and so forth. Accordingly, various embodiments of the invention reflect an appreciation that provision of such PCH 262 functionalities may require a different implementation for each processor architecture.

In various embodiments, the SPI Flash 214 memory may be implemented to receive, store, manage, and provide access to one or more BIOS components ‘A’ 216, as described in greater detail herein. In various embodiments, the SPI Flash 214 memory may likewise be implemented to include certain NVRAM 218 memory. In various embodiments, the NVRAM 218 memory may in turn be implemented to receive, store, manage, and provide access to one or more BIOS variables ‘A’ 220, as described in greater detail herein.

In various embodiments, the NVMe 222 memory may be implemented to include a boot partition (BP) 224, described in greater detail herein. In various embodiments, the BP 224 may in turn be implemented to receive, store, and provide access to, one or more BIOS components ‘B’ 226. In various embodiments, the NVMe 222 memory may be implemented without a BP 224. Nonetheless, the NVMe 222 memory may be implemented in certain of these embodiments to still receive, store, manage, and provide access to one or more BIOS components ‘B’ 226. In various embodiments, as likewise described in greater detail herein, the CMOS 228 chip may be implemented to receive, store, and provide access to, one or more BIOS variables ‘B’ 230.

In various embodiments, the one or more DIMMs 324 may be implemented to include one or more RAM modules mounted onto an integrated circuit board. In various embodiments, the one or more DIMMs 324 may be partitioned into a low region of memory, such as from 1 megabyte (MB) 326 to 1 gigabyte (GB) 328, and a high region of memory, such as from 1 GB 328 to 4 GB 330. In these embodiments, the amount of memory allocated to the low and high memory regions, the memory addresses within the one or more DIMMs 324 where such allocation may occur, and how such allocation may be performed, is a matter of design choice.

In various embodiments, the HDD/SDD memory 332 may be implemented to include an extensible firmware interface (EFI) system partition (ESP) 334. Skilled practitioners of the art will be familiar with an ESP 334, which is usually implemented as a partition on a mass storage device, such as HDD/SSD memory 332, which in turn is used by an associated IHS implemented with a Unified Extensible Firmware Interface (UEFI), described in greater detail herein. In such implementations, the UEFI loads files stored within the ESP 334 to begin installing Operating System (OS) and associated utility files. In various embodiments, the ESP 334 may be implemented to contain the boot loaders, or kernel images, for all installed OS's that may be contained in other memory partitions, device driver files for hardware devices present in its associated IHS and used by the firmware at boot time, system utility programs that are intended to be run before a particular OS is booted, and data files such as error logs.

In various embodiments, the ASDFMP 300 may be implemented to include an OS runtime phase 304, and various pre-boot phases 310, all of which are described in greater detail herein. In various embodiments, the OS runtime phase 304 may be implemented to include a user mode 306 and a kernel mode 308, both of which are likewise described in greater detail herein. In various embodiments, certain components, processes, or operations, or a combination thereof, respectively associated with the OS runtime phase 304 and the pre-boot phases 310, may be implemented to interact with various components of the platform architecture 302, as likewise described in greater detail herein.

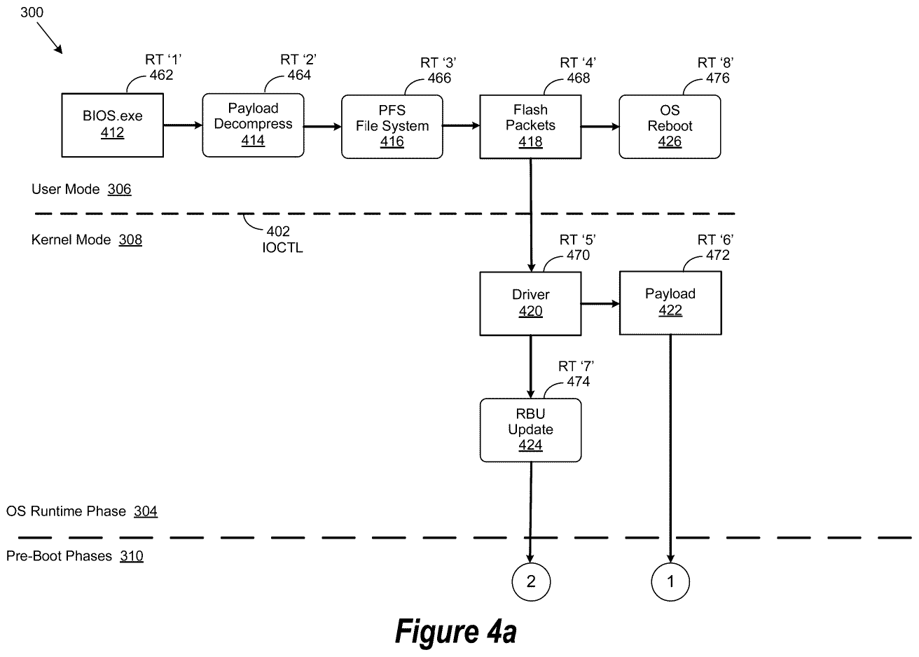

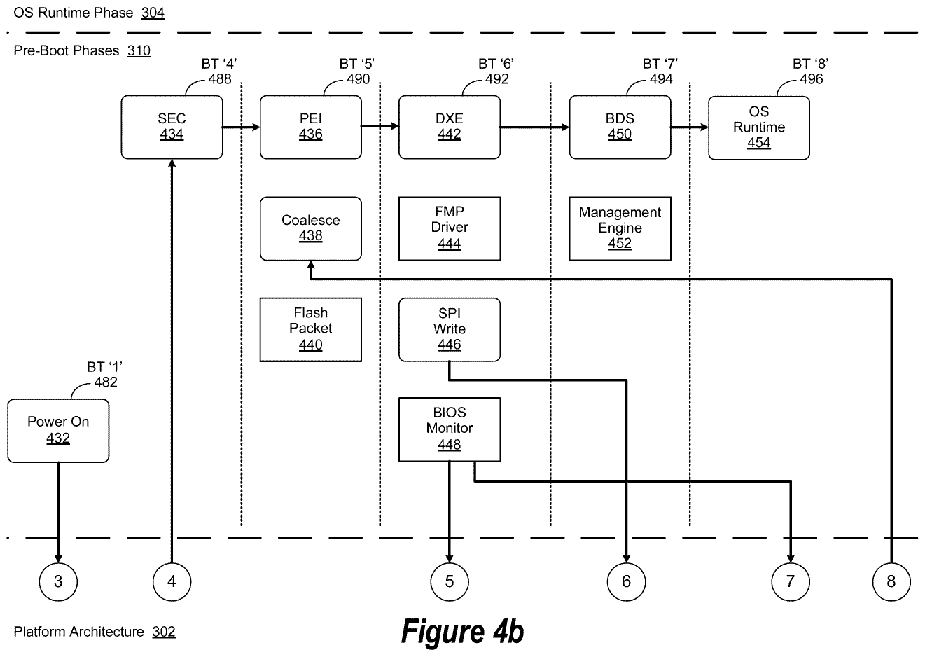

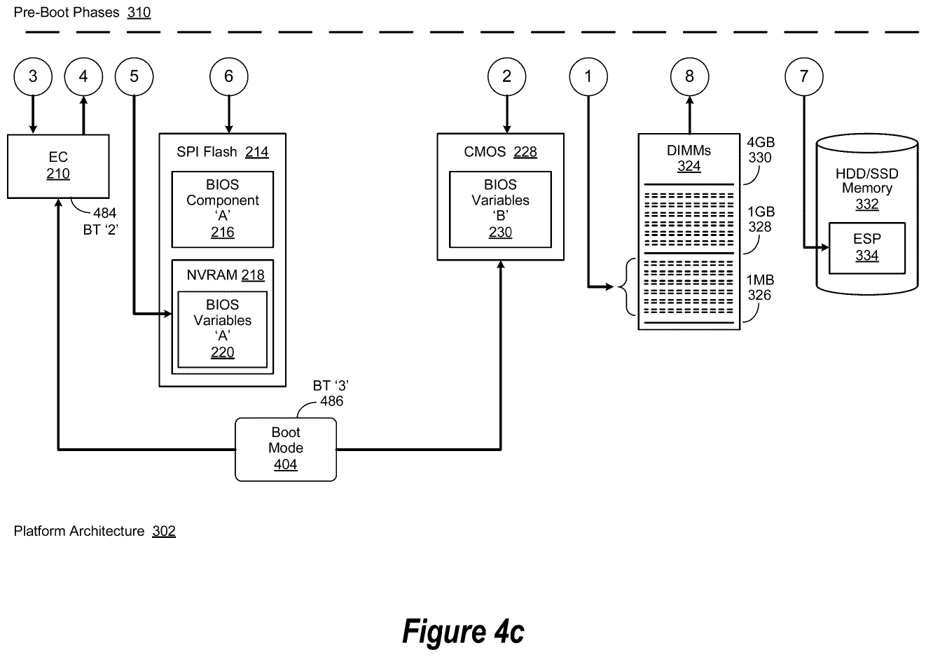

FIGS. 4a through 4c are a simplified block diagram showing an architecture-specific distributed firmware management platform (ASDFMP) implemented in accordance with an embodiment of the invention to perform certain distributed firmware management operations. In certain embodiments, the ASDFMP 300 may be implemented to include an Operating System (OS) runtime phase 304, various pre-boot phases 310, and a platform architecture 302. In various embodiments, as described in greater detail herein, the platform architecture 302 may be implemented to include an embedded controller (EC) 210, Serial Peripheral Interface (SPI) Flash 214 memory, and a complementary metal-oxide-semiconductor (CMOS) 228 chip, or a combination thereof. In various embodiments, the platform architecture 302 may likewise be implemented to include one or more dual in-line memory modules (DIMMs) 324, and certain hard disk drive (HDD) memory, or solid state drive (SSD) memory, or a combination of the two 332.

In various embodiments, the SPI Flash 214 memory may be implemented to receive, store, manage, and provide access to one or more Basic Input/Output System (BIOS) components ‘A’ 216, described in greater detail herein. In various embodiments, the SPI Flash 214 memory may likewise be implemented to include certain NVRAM 218 memory, likewise described in greater detail herein. In various embodiments, the NVRAM 218 memory may in turn be implemented to receive, store, manage, and provide access to one or more BIOS variables ‘A’ 220, as described in greater detail herein.

In various embodiments, the OS runtime phase 304 may be implemented to include a user mode 306 and a kernel mode 308. Skilled practitioners of the art will be aware that user mode 306 generally refers to a restricted mode that limits software access to system resources, while kernel mode 308 generally refers to a privileged mode that allows software to access system resources and perform privileged operations. In various embodiments, an Input/Output Control (IOCTL) 402 operation, familiar to those of skill in the art, may be performed to switch between user mode 306 and kernel mode 308. Those of skill in the art will likewise be aware that such mode switching generally involves saving the current context of an associated information handling system's (IHS's) processor in memory, switching to the new mode, and loading the new context into the processor.

Referring now to FIG. 4a, a distributed firmware management operation may be initiated by the ASDFMP 300 receiving a BIOS.exe 412 file in runtime (RT) step ‘1’ 462. In various embodiments, the BIOS.exe 412 file may be implemented as the combination of a flash memory utility and a payload of firmware components, described in greater detail herein. Then, in RT step ‘2’ 464 the BIOS.exe 412 is executed to decompress 414 its payload, which is then converted in RT step ‘3’ 466 into a payload file system (PFS) 416.

Flash memory packets 418 are then extracted from the PFS 416 if RT step ‘4’ 468 and provided to a memory driver 420 in RT step ‘5’ 470 to create a memory payload 422. The resulting memory payload 422 is then loaded into a lower memory region of one or more DIMMs 324, such as between 1 megabyte (MB) 326 and 1 gigabyte (GB) 328. Thereafter, a Remote BIOS Update (RBU) 424 operation may be performed in RT step ‘7’ to update certain BIOS variables ‘B’ 230 stored in the CMOS 328 chip. An OS reboot 426 operation is then performed in RT step ‘8’ 476.

Once the OS reboot 426 operation has been performed in RT step ‘8’ 476, power is applied 432 to the ASDFMP 300 in pre-boot time (BT) step ‘1’ 432. An embedded controller (EC) 210 is then invoked in BT step ‘2’ 464 which results in the activation of a boot mode 404 in BT step ‘3’ 486. In various embodiments, the boot mode 404 may be activated in BT step ‘3’ 486 by retrieving, and using, certain BIOS variables ‘B’ stored in the CMOS 228 chip.

One or more security (SEC) 434 phase operations may then be performed in BT step ‘4’ 488, followed by the performance of one or more Pre Extensible Firmware Interface (EFI) Initialization (PEI) 436 phase operations in BT step ‘5’ 436. In various embodiments, the one or more SEC 434 phase operations may be implemented to secure the boot process by preventing the loading of Unified Extensible Firmware Interface (UEFI) drivers, or boot loaders, that are not signed with an acceptable digital signature. In various embodiments, a trusted platform module (TPM), familiar to skilled practitioners of the art, may be used in the performance of one or more SEC 434 phase operations.

Those of skill in the art will likewise be aware that PEI 436 phase operations are generally performed to initialize permanent memory within a particular IHS to load and invoke initial configuration routines specific to its associated processor environment (PE), described in greater detail herein. In various embodiments, performance of the PEI 436 phase operation in BT step ‘5’ 436 may include one of more packet coalescing 438 operations being performed to coalesce individual flash memory packets previously stored in a low memory region of one or more DIMMs in RT step ‘6’ 472. In various embodiments, the individual flash memory packets may then be stored as one or more coalesced flash memory packets 440.

In various embodiments, a firmware management protocol (FMP) may be used in the performance of a Driver execution Environment (DXE) 442 phase operation in BT step 6′ 442 to perform an SPI write 446 operation to write the coalesced flash memory packets 440 to SPI Flash 214 memory. Skilled practitioners of the art will be familiar with a DXE 442, which as typically implemented includes a DXE Core, a DXE Dispatcher, and one or more Firmware Management Protocol (FMP) drivers 444. In general, the DXE Core component is responsible for producing a set of boot services, DXE services, and RT Services. Likewise, the DXE Dispatcher component is responsible for discovering and executing FMP drivers 444 in the correct order. In turn, the FMP drivers 444 are responsible for initializing the IHS's processor environment (PE), described in greater detail herein. In various embodiments, the SPI write 446 operation may be performed to write certain flash memory packets associated with certain BIOS components ‘A’ 216, or certain BIOS variables ‘A’ 220, or a combination of the two. In various embodiments, the flash memory packets may contain new, updated, modified, revised, or replacement BIOS components ‘A’ 216, or BIOS variables ‘A’ 220, or a combination of the two.

In various embodiments, a BIOS monitor 448, such as BIOS IQ, produced by Dell® Incorporated, of Round Rock, Texas, may be implemented within the DXE 442 phase to monitor the current values of certain BIOS variables ‘A’ 220 stored in NVRAM 218, which in certain embodiments, may be implemented within SPI Flash 214 memory. In various embodiments, the BIOS monitor 448 may likewise be implemented to monitor the status of certain data stored in the ESP 334, described in greater detail herein. Once DXE 442 phase operations are completed in BT step ‘6’ 450, the OS is then booted. In various embodiments, a boot device selection (BDS) 450 phase operation is then performed in BT step ‘7’ 450 to select a boot device. In various embodiments, a management engine (ME) 452, such as the ME 452 produced by Intel® Corporation of Santa Clara, California, may be implemented to use the selected boot device in BT step ‘8’ 454 to boot the ASDFMP 300 into an OS runtime 454 state.

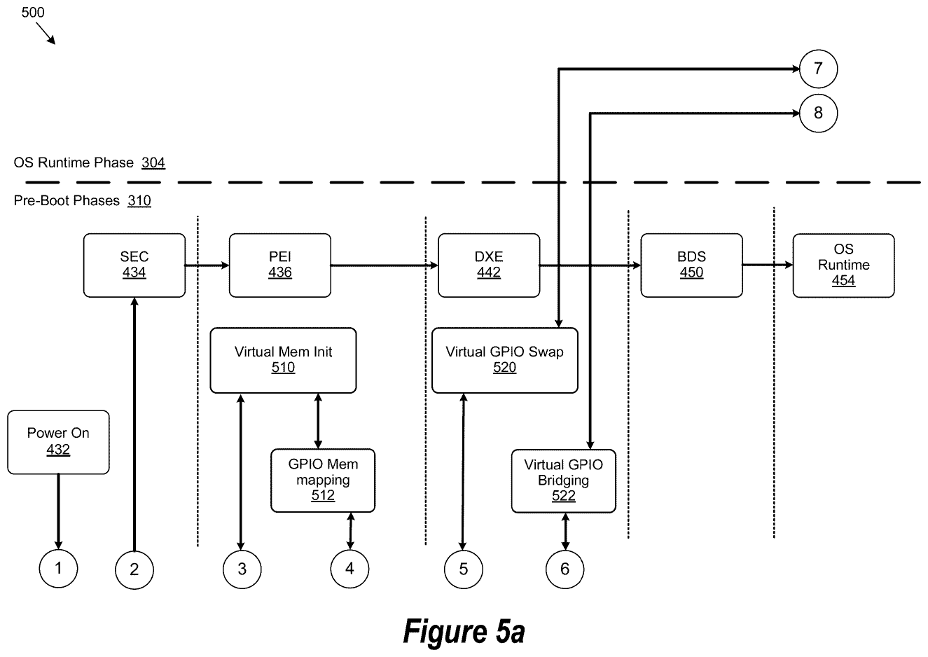

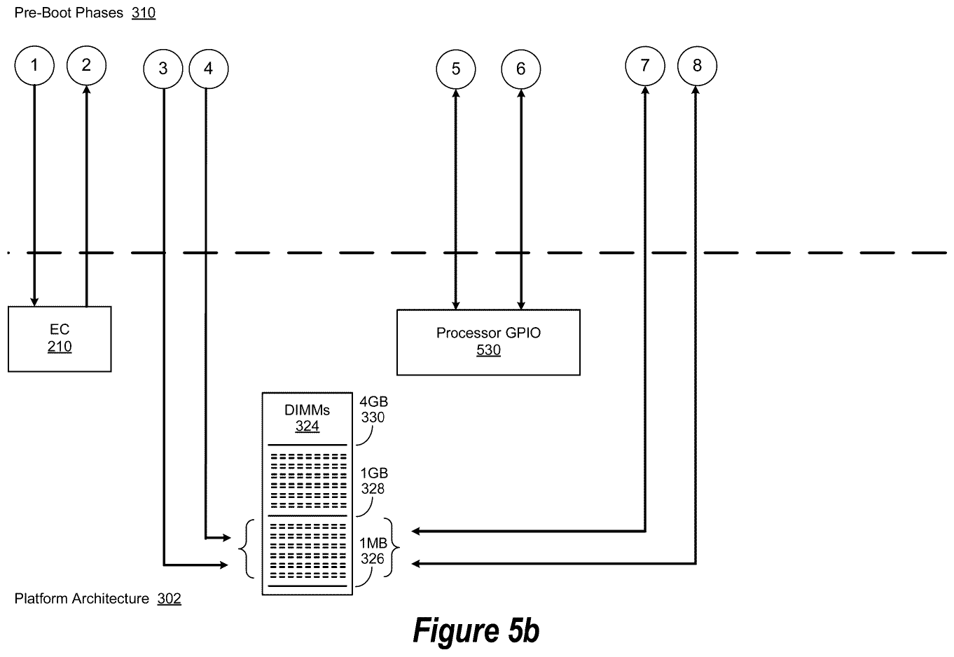

FIGS. 5a and 5b, generally referred to as FIG. 5, show an architecture-specific distributed firmware management platform (ASDFMP) implemented in accordance with an embodiment of the invention to perform a processor environment agnostic GPIO virtualization operation 500. In certain embodiments, the processor environment agnostic GPIO virtualization operation 500 is performed within an information handling system such as information handling system 100. In certain embodiments, the processor environment agnostic GPIO virtualization operation 500 is performed within a multi-processor operating environment such as multi-processor operating environment 200. In certain embodiments, the processor environment agnostic GPIO virtualization operation 500 is performed via a processor environment agnostic GPIO virtualization system. In certain embodiments, the processor environment agnostic GPIO virtualization system is included within a platform architecture such as platform architecture 302. As used herein, a GPIO virtualization operation broadly refers to a firmware management operation, described in greater detail herein, performed, directly or indirectly, within a multi-processor operating environment 200 to detect, rectify, or a combination thereof, one or more issues associated with a GPIO line of an information handling system. As used herein, processor environment agnostic GPIO virtualization operation broadly refers to a GPIO virtualization operation which is processor environment agnostic.

In certain embodiments, the processor environment agnostic GPIO virtualization operation includes generating and using a virtual GPIO swap protocol. As used herein, a virtual GPIO swap protocol broadly refers to a standardized set of rules for formatting and processing data used in the performance of a virtual GPIO swap operation. In certain embodiments, the GPIO swap operation enables swapping of a malfunctioning GPIO line with a new operation memory area, reinitializes the malfunctioning GPIO line to an original functional state, or a combination thereof. In certain embodiments, the GPIO swap operation interacts with the virtual GPIO swap protocol. In certain embodiments, the virtual GPIO swap protocol is used when communicating with an application, any of a plurality of processor components (such as the components described with respect to the multi-processor operating environment in FIG. 2), or a combination thereof, regarding virtual GPIO swap information associated with the performance of a virtual GPIO swap operation.

In certain embodiments, the processor environment agnostic GPIO virtualization operation includes generating and using a GPIO bridging protocol. As used herein, a GPIO bridging protocol broadly refers to a standardized set of rules for formatting and processing data used in the performance of a GPIO bridging operation. In certain embodiments, the GPIO bridging operation dynamically extends a functional range for a GPIO pin across multiple devices. In certain embodiments, the GPIO bridging protocol is used when communicating with an application, any of a plurality of processor components (such as the components described with respect to the multi-processor operating environment in FIG. 2), or a combination thereof, regarding GPIO bridging information associated with the performance of a GPIO bridging operation.

Referring now to FIG. 5, the processor environment agnostic GPIO virtualization operation 500 starts when power is applied 432 to the ASDFMP. Upon power on, an embedded controller 210 is accessed during the SEC 434 phase. Next, the operation 500 transfers control to the PEI 436 phase.

Next, during the PEI 436 phase, a GPIO virtual memory initialization operation 510 is performed to initialize a GPIO virtual memory region. Next, a GPIO memory mapping operation 512 is performed to map the GPIO virtual memory region for use when performing a GPIO virtualization operation. In certain embodiments, the GPIO memory virtualization region is included within random access memory of the information handling system. In certain embodiments, the GPIO memory virtualization region is included within one or more DIMMs 324 of the information handling system. In certain embodiments, the GPIO memory virtualization location is located within a low region 326 of memory, such as from 1 megabyte (MB) to 1 gigabyte (GB), of the random access memory.

In certain embodiments, when the processor environment agnostic GPIO virtualization operation 500 completes the GPIO memory mapping operation 512, the processor environment agnostic GPIO virtualization operation 500 transfers control to the DXE 442 phase. In certain embodiments, the processor environment agnostic GPIO virtualization operation 500 performs a virtual GPIO swap operation 520. In certain embodiments, the virtual GPIO swap operation 520 is performed during the DXE 442 phase. In certain embodiments, the virtual GPIO swap operation 520 is performed upon detection of a GPIO malfunction. In certain embodiments, the virtual GPIO swap operation 520 uses a GPIO swap protocol.

In certain embodiments, when the processor environment agnostic GPIO virtualization operation 500 completes the virtual GPIO swap operation 520, the processor environment agnostic GPIO virtualization operation 500 performs a virtual GPIO bridging operation 522. In certain embodiments, the virtual GPIO bridging operation 522 is performed during the DXE 442 phase. In certain embodiments, the virtual GPIO bridging operation 522 uses a GPIO bridging protocol.

In certain embodiments, the processor environment agnostic GPIO virtualization operation 500 monitors one or more GPIO circuits to detect whether a GPIO malfunction has occurred. In certain embodiments, the one or more GPIO circuits are included within one or more processors, such as processors ‘1’ 206 through ‘n’ 208, of a particular processor environment. In certain embodiments, the monitoring of the GPIO circuits is processor environment agnostic. In certain embodiments, the virtual GPIO swap operation 520 accesses the GPIO virtualization memory region when performing the GPIO swap operation. In certain embodiments, the GPIO bridging operation accesses the GPIO virtualization memory region when performing the GPIO bridging operation.

In certain embodiments, the virtual GPIO swap protocol, the GPIO bridging protocol, or a combination thereof, interact with one or more GPIO circuits 530. In certain embodiments, the virtual GPIO swap protocol, the GPIO bridging protocol, or a combination thereof, interact with one or more GPIO circuits of a processor. In certain embodiments, the virtual GPIO swap protocol, the GPIO bridging protocol, or a combination thereof, interact with one or more GPIO circuits of a processor of a particular processor environment. In certain embodiments, the interaction with the one or more GPIO circuits is processor agnostic.

In certain embodiments, after the GPIO swap operation 520, the GPIO bridging operation 522, or a combination thereof, complete operation, the processor environment agnostic GPIO virtualization operation 500 transfers control to the BDS 450 phase and the pre-boot operation continues to an OS runtime phase 454. In certain embodiments, after being initialized and mapped during the pre-boot phases 310, the GPIO swap operation 520, the GPIO bridging operation 522, or a combination thereof, can also interact with the memory during the OS runtime phase 304.

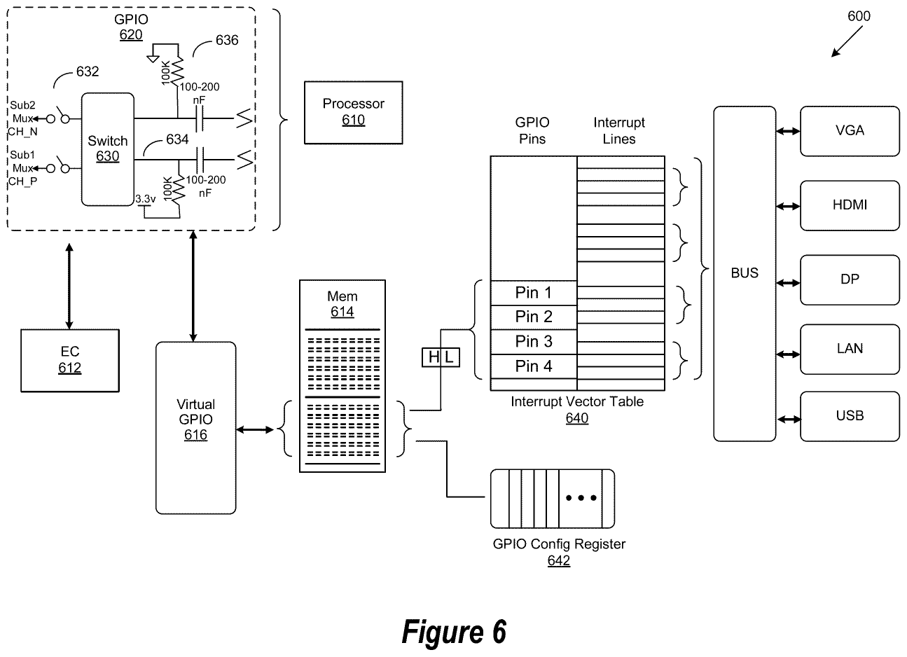

FIG. 6 shows a simplified block diagram of a processor environment agnostic GPIO virtualization system 600. In certain embodiments, the processor environment agnostic GPIO system is implemented within an architecture-specific distributed firmware management platform. In certain embodiments, the processor environment agnostic GPIO virtualization system is implemented an information handling system such as information handling system 100. In certain embodiments, the processor environment agnostic GPIO virtualization system 600 is implemented within a multi-processor operating environment such as multi-processor operating environment 200. In certain embodiments, the processor environment agnostic GPIO virtualization system 600 is implemented within a platform architecture such as platform architecture 302.

In certain embodiments, the processor environment agnostic GPIO virtualization system 600 performs a processor environment agnostic GPIO virtualization operation. As used herein, a GPIO virtualization operation broadly refers to a firmware management operation, described in greater detail herein, performed, directly or indirectly, within a multi-processor operating environment 200 to detect, rectify, or a combination thereof, one or more issues associated with a GPIO line of an information handling system. As used herein, processor environment agnostic GPIO virtualization operation broadly refers to a GPIO virtualization operation which is processor environment agnostic.

In certain embodiments, the processor environment agnostic GPIO system 600 includes a processor 610, an embedded controller 612, a memory 614, a virtual GPIO component 616, or a combination thereof. In certain embodiments, the processor 610 implements one or more GPIO circuits 620. In certain embodiments, each GPIO circuit 620 includes a switch component 630, a multiplexer portion 632, a pull up circuit 634, a pull down circuit 636, or a combination thereof. In certain embodiments, the pull up circuit 634, the pull down circuit 636, or a combination thereof, provide termination options that include termination resistors which may be connected to a voltage or to ground, respectively.

In certain embodiments, the multiplexer portion 632 includes a first GPIO signal line portion (SUB1 MUX CH_P), a second GPIO signal line portion (SUB2 MUX CH_N) or a combination thereof. In certain embodiments, the GPIO circuit 620 uses the multiplexer portion 630 to configure each GPIO signal pin as a receiver (RX) path or transmitter (TX) path, each which can be enabled by configuration registers.

In certain embodiments the processor environment agnostic GPIO system 600 further includes an interrupt vector table (IVT) 640, a GPIO configuration register 642, or a combination thereof. In certain embodiments, the interrupt vector table 640, the GPIO configuration register portion 642, or a combination thereof, are instantiated within the memory 614. In certain embodiments, the interrupt vector table 640, the GPIO configuration register portion 642, or a combination thereof, are instantiated within a low region of memory, such as from 1 megabyte (MB). In certain embodiments, the GPIO configuration register portion 642 includes one or more multi bit registers. In certain embodiments, the GPIO register portion 642 includes a plurality of 8-bit registers. In certain embodiments, each bit of the register controls an aspect of a GPIO circuit configuration. In certain embodiments, the GPIO configuration register 642 is managed via firmware such as the unified BIOS. In certain embodiments, the GPIO configuration register set 642 initializes firmware memory mapped virtual GPIO PINs. In certain embodiments, providing the firmware memory mapped virtual GPIO pins enables dynamic control of GPIO PIN signals to reset the device functions. In certain embodiments, the interrupt vector table 640 includes a GPIO pin portion and an interrupt line portion. In certain embodiments, the GPIO pin portion associates a particular GPIO pin with a particular component of the GPIO system 600.

In certain embodiments, the processor environment agnostic GPIO system 600 further includes one or more components which are controlled via a GPIO circuit. In certain embodiments, the one or more components includes a video graphics adapter (VGA) component, a high definition multimedia interface (HDMI) component, a display port (DP) component, a local area network (LAN) component, a universal serial bus (USB) component, or a combination thereof. In certain embodiments, the one or more peripheral components are coupled to a bus. In certain embodiments, the bus includes a platform controller hub (PCH) bus. In certain embodiments, the one or more peripheral components communicate with the interrupt vector table 640 via the bus.

In certain embodiments, the processor environment agnostic GPIO virtualization operation is performed using the virtual GPIO component 616. In certain embodiments, the virtual GPIO component interacts with a virtual GPIO protocol. As used herein, a virtual GPIO protocol broadly refers to a standardized set of rules for formatting and processing data used in the performance of a virtual GPIO operation. In certain embodiments, a virtual GPIO operation detects, rectifies, or a combination thereof, a malfunctioning GPIO line. In certain embodiments, the virtual GPIO protocol is used when communicating with an application, any of a plurality of processor components (such as the components described with respect to the multi-processor operating environment in FIG. 2), or a combination thereof, regarding virtual GPIO information associated with the performance of a virtual GPIO operation. In certain embodiments, a GPIO swap protocol is an example of a virtual GPIO protocol.

In certain embodiments, a memory mapped IO space is created during the PEI phase. In certain embodiments, the memory mapped IO spaces uses the low memory region of memory. In certain embodiments particular GPIO circuits are seamlessly attached to these memory spaces. More specifically, during initialization a virtual GPIO pins per device map is created as:
(i) MEM_VGPIO_CFG_xxx.IOTERM,
(ii) MEM_VGPIO_CFG_xxx.IOSTATE,
(iii) MEM_VGPIO_CFG_xxx.IOSSTATE.
   In certain embodiments, certain aspects of the virtual GPIO pins per device map is generated per device in a GPIO memory range.

In operation, when a GPIO pin malfunction is detected, the VGPIO_CFG_IOSTATE is notified for voltage reset. Next the virtualization operation transitions to a GPIO remediation state operation. In certain embodiments, when operating in the GPIO remediation state a plurality of rectification steps are executed within a particular firmware GPIO context.

In certain embodiments, the plurality of rectification steps include:
Set device specific GPIO PIN PAD_CFG_DW1_GPIO_xxx.IOSTATE=0 h (RX disable)
Set PAD_CFG_DW1_GPIO_xxx.IOTERM=0b
Map the GPIO circuit resisters to a virtual GPIO register area
Set PAD_CFG_DW1_GPIO_xxx.IOSTATE=5 h (RX disable)
Set PAD_CFG_DW1_GPIO_xxx.IOTERM=1b by enabling standby status
On all connected GPIO circuits execute a GPIO pull-up function to provide proper boot operation by running PAD_CFG_DW1_GPIO_xxx.IOTERM termination on an external resistor. (This operation can sometimes require a reboot, but most of the time a reboot is not needed.)
Clear all VGPIO configuration (CFG) set registers and reinitialize native device GPIO configuration set to default voltage.

Accordingly, GPIO device specific functionality is restored to the malfunctioning GPIO circuit. In certain embodiments, the GPIO device specific functionality includes the impedance and resister voltages being pulled up and down in the virtual GPIO address space without causing any hardware corruptions.

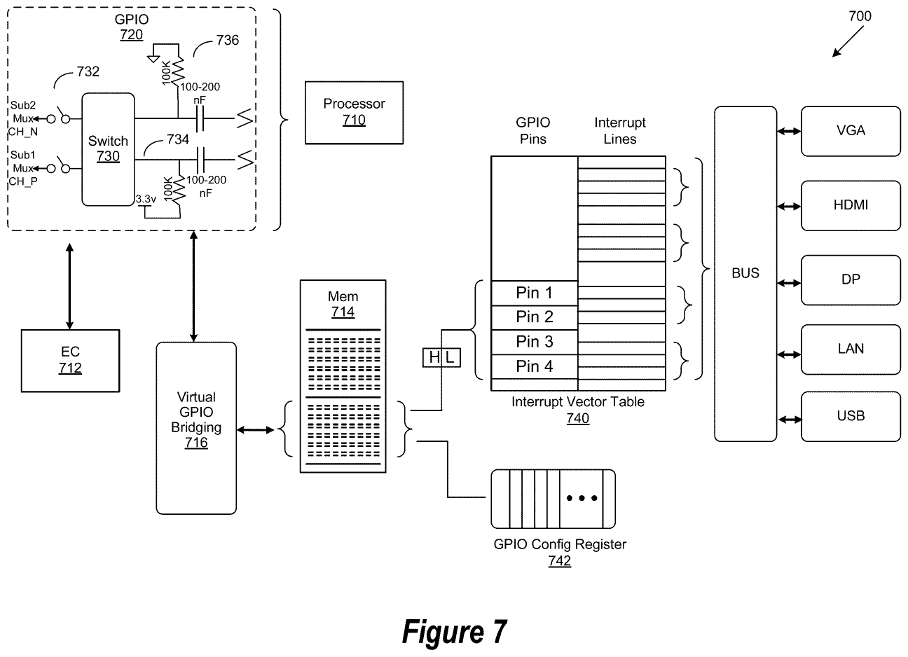

FIG. 7 shows a simplified block diagram of a processor environment agnostic GPIO virtualization system 700 which includes a GPIO bridging component. In certain embodiments, the processor environment agnostic GPIO system is implemented within an architecture-specific distributed firmware management platform. In certain embodiments, the processor environment agnostic GPIO virtualization system is implemented an information handling system such as information handling system 100. In certain embodiments, the processor environment agnostic GPIO virtualization system 700 is implemented within a multi-processor operating environment such as multi-processor operating environment 200. In certain embodiments, the processor environment agnostic GPIO virtualization system 700 is implemented within a platform architecture such as platform architecture 302.

In certain embodiments, the processor environment agnostic GPIO virtualization system 700 performs a processor environment agnostic GPIO virtualization operation. As used herein, a GPIO virtualization operation broadly refers to a firmware management operation, described in greater detail herein, performed, directly or indirectly, within a multi-processor operating environment 200 to detect, rectify, or a combination thereof, one or more issues associated with a GPIO line of an information handling system. As used herein, processor environment agnostic GPIO virtualization operation broadly refers to a GPIO virtualization operation which is processor environment agnostic.

In certain embodiments, the processor environment agnostic GPIO system 700 includes a processor 710, an embedded controller 712, a memory 714, a virtual GPIO bridging component 716, or a combination thereof. In certain embodiments, the processor 710 implements one or more GPIO circuits 720. In certain embodiments, each GPIO circuit 720 includes a switch component 730, a multiplexer portion 732, a pull up circuit 734, a pull down circuit 736, or a combination thereof. In certain embodiments, the pull up circuit 734, the pull down circuit 736, or a combination thereof, provide termination options that include termination resistors which may be connected to a voltage or to ground, respectively.

In certain embodiments, the multiplexer portion 732 includes a first GPIO signal line portion (SUB1 MUX CH_P), a second GPIO signal line portion (SUB2 MUX CH_N) or a combination thereof. In certain embodiments, the GPIO circuit 720 uses the multiplexer portion 730 to configure each GPIO signal pin as a receiver (RX) path or transmitter (TX) path, each which can be enabled by configuration registers.

In certain embodiments the processor environment agnostic GPIO system 700 further includes an interrupt vector table (IVT) 740, a GPIO configuration register 742, or a combination thereof. In certain embodiments, the interrupt vector table 740, the GPIO configuration register 742, or a combination thereof, are instantiated within the memory 714. In certain embodiments, the interrupt vector table 740, the GPIO configuration register 742, or a combination thereof, are instantiated within a low region of memory, such as from 1 megabyte (MB). In certain embodiments, the GPIO configuration register 742 includes one or more multi bit registers. In certain embodiments, each bit of the register controls an aspect of a GPIO circuit configuration. In certain embodiments, the GPIO configuration register 742 is managed via firmware such as the unified BIOS. In certain embodiments, the GPIO configuration register set 742 initializes firmware memory mapped virtual GPIO PINs. In certain embodiments, providing the firmware memory mapped virtual GPIO pins enables dynamic control of GPIO PIN signals to reset the device functions. In certain embodiments, the interrupt vector table 740 includes a GPIO pin portion and an interrupt line portion. In certain embodiments, the GPIO pin portion associates a particular GPIO pin with a particular component of the GPIO system 700.

In certain embodiments, the processor environment agnostic GPIO system 700 further includes one or more components which are controlled via a GPIO circuit. In certain embodiments, the one or more components includes a video graphics adapter (VGA) component, a high definition multimedia interface (HDMI) component, a display port (DP) component, a local area network (LAN) component, a universal serial bus (USB) component, or a combination thereof. In certain embodiments, the one or more peripheral components are coupled to a bus. In certain embodiments, the bus includes a platform controller hub (PCH) bus. In certain embodiments, the one or more peripheral components communicate with the interrupt vector table 740 via the bus.

In certain embodiments, a processor environment agnostic GPIO virtualization bridging operation is performed using the virtual GPIO bridging component 716. In certain embodiments, the virtual GPIO bridging operation dynamically extends a functional range for a GPIO pin across multiple devices. In certain embodiments, dynamically extending the functional range of the GPIO pin avoids a need for a firmware update. In certain embodiments, peripheral device suppliers can provide specific code implementations to support any new GPIO functions.

In certain embodiments, the processor environment agnostic GPIO virtualization operation includes generating and using a GPIO bridging protocol. In certain embodiments, the virtual GPIO bridging component 716 interacts with the virtual GPIO bridging protocol. As used herein, a virtual GPIO bridging protocol broadly refers to a standardized set of rules for formatting and processing data used in the performance of a virtual GPIO bridging operation. In certain embodiments, the virtual GPIO bridging protocol is used when communicating with an application, any of a plurality of processor components (such as the components described with respect to the multi-processor operating environment in FIG. 2), or a combination thereof, regarding virtual GPIO bridging information associated with the performance of a virtual GPIO bridging operation. In certain embodiments, the processor environment agnostic GPIO virtualization operation includes the processor environment agnostic GPIO virtualization bridging operation.

As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

Consequently, the invention is intended to be limited only by the spirit and scope of the appended claims, giving full cognizance to equivalents in all respects.

What is claimed is:

1. A computer-implementable method for performing a firmware management operation, comprising:
providing an information handling system with a distributed unified BIOS;
identifying a processor environment installed on an information handling system from a plurality of processor environments, the processor environment comprising a processor architecture the processor architecture comprising a general purpose 6 input/output (GPIO) circuit, the GPIO circuit comprising a GPIO signal pin; and,
performing a processor environment agnostic GPIO virtualization operation via the distributed unified BIOS, the processor environment agnostic GPIO virtualization operation detecting and rectifying a malfunctioning GPIO signal pin.

2. The method of claim 1, wherein:
the processor environment agnostic GPIO virtualization operation includes a processor environment agnostic GPIO virtualization swap operation.

3. The method of claim 2, wherein:
the processor environment agnostic GPIO virtualization swap operation swapping a malfunctioning GPIO signal line with a new operation memory area and reinitializing the malfunctioning GPIO signal line to an original functional state.

4. The method of claim 1, wherein:
the processor environment agnostic GPIO virtualization operation includes a processor environment agnostic GPIO virtualization bridging operation.

5. The method of claim 4, wherein:
the processor environment agnostic GPIO virtualization bridging operation dynamically extending a functional range for a GPIO signal line across a plurality of devices.

6. The method of claim 1, wherein:
the processor architecture includes a memory; and,
the processor environment agnostic GPIO virtualization operation initializes and maps a GPIO virtualization region within the memory.

7. A system comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations and comprising instructions executable by the processor and configured for:
providing an information handling system with a distributed unified BIOS;
identifying a processor environment installed on an information handling system from a plurality of processor environments, the processor environment comprising a processor architecture the processor architecture comprising a general purpose input/output (GPIO) circuit, the GPIO circuit comprising a GPIO signal pin; and,
performing a processor environment agnostic GPIO virtualization operation via the distributed unified BIOS, the processor environment agnostic GPIO virtualization operation detecting and rectifying a malfunctioning GPIO signal pin.

8. The system of claim 7, wherein:
the processor environment agnostic GPIO virtualization operation includes a processor environment agnostic GPIO virtualization swap operation.

9. The system of claim 8, wherein:
the processor environment agnostic GPIO virtualization swap operation swapping a malfunctioning GPIO signal line with a new operation memory area and reinitializing the malfunctioning GPIO signal line to an original functional state.

10. The system of claim 7, wherein:
the processor environment agnostic GPIO virtualization operation includes a processor environment agnostic GPIO virtualization bridging operation.

11. The system of claim 10, wherein:
the processor environment agnostic GPIO virtualization bridging operation dynamically extending a functional range for a GPIO signal line across a plurality of devices.

12. The system of claim 7, wherein:
the processor architecture includes a memory; and,
the processor environment agnostic GPIO virtualization operation initializes and maps a GPIO virtualization region within the memory.

13. A non-transitory, computer-readable storage medium embodying computer program code, the computer program code comprising computer executable instructions configured for:
providing an information handling system with a distributed unified BIOS;
identifying a processor environment installed on an information handling system from a plurality of processor environments, the processor environment comprising a processor architecture the processor architecture comprising a general purpose input/output (GPIO) circuit, the GPIO circuit comprising a GPIO signal pin; and,
performing a processor environment agnostic GPIO virtualization operation via the distributed unified BIOS, the processor environment agnostic GPIO virtualization operation detecting and rectifying a malfunctioning GPIO signal pin.

14. The non-transitory, computer-readable storage medium of claim 13, wherein:
the processor environment agnostic GPIO virtualization operation includes a processor environment agnostic GPIO virtualization swap operation.

15. The non-transitory, computer-readable storage medium of claim 14, wherein:
the processor environment agnostic GPIO virtualization swap operation swapping a malfunctioning GPIO signal line with a new operation memory area and reinitializing the malfunctioning GPIO signal line to an original functional state.

16. The non-transitory, computer-readable storage medium of claim 13, wherein:
the processor environment agnostic GPIO virtualization operation includes a processor environment agnostic GPIO virtualization bridging operation.

17. The non-transitory, computer-readable storage medium of claim 16, wherein:
the processor environment agnostic GPIO virtualization bridging operation dynamically extending a functional range for a GPIO signal line across a plurality of devices.

18. The non-transitory, computer-readable storage medium of claim 13, wherein:
the processor architecture includes a memory; and,
the processor environment agnostic GPIO virtualization operation initializes and maps a GPIO virtualization region within the memory.

19. The non-transitory, computer-readable storage medium of claim 13, wherein:
the computer executable instructions are deployable to a client system from a server system at a remote location.

20. The non-transitory, computer-readable storage medium of claim 13, wherein:
the computer executable instructions are provided by a service provider to a user on an on-demand basis.
